(19) United States
(12) Patent Application Publication
(10) Pub. No.: US 2016/0185611 A1
(43) Pub. Date: Jun. 30, 2016

(54) AMMONIA STORAGE STRUCTURE AND ASSOCIATED SYSTEMS

(71) Applicant: AAQIUS & AAQIUS SA, Genève (CH)

(72) Inventor: Jean-Baptiste DEMENTHON, Paris (FR)

(73) Assignee: AAQIUS & AAQIUS SA, Geneva (CH)

(21) Appl. No.: 14/783,610

(22) PCT Filed: Apr. 11, 2014
(86) PCT No.: PCT/EP2014/057445

§ 371 Date: Dec. 29, 2015

(30) Foreign Application Priority Data
Apr. 12, 2013 (FR) 1353366

(51) Int. Cl. C01C 1/00; B01J 7/00; F01N 3/20

(52) U.S. Cl. CPC C01C 1/003; F01N 3/2066; F01N 3/2006; B01J 7/00; F01N 2610/02

(57) ABSTRACT

The disclosure relates to an ammonia storage structure in particular for the selective catalytic reduction of nitrogen oxides in the exhaust gases of combustion vehicles, including at least one storage material in which the ammonia can be stored, where the structure includes at least two different storage portions, each storage portion containing a storage material, each storage portion being associated with a corresponding heating element, such that the two storage portions can be heated differently with a view to releasing the ammonia thereof differently. The disclosure also relates to an ammonia storage and removal system of a vehicle that includes a storage chamber, including such a storage structure. A selective catalytic reduction system for internal combustion engine exhaust gases, includes such an ammonia storage system and to a module for feeding ammonia into the exhaust gases.

### CROSS-REFERENCE TO RELATED APPLICATIONS

This application is a National Phase Entry of International Patent Application No. PCT/EP2014/057445, filed on Apr. 11, 2014, which claims priority to French Patent Application Serial No. 1353366, filed on Apr. 12, 2013, both of which are incorporated by reference herein.

### BACKGROUND AND SUMMARY

The invention generally relates to gas storage in solids. This type of storage generally enables a gas to be stored at storage pressures lower than those experienced in the case of a purely gaseous storage. Applications for this storage type are various and relate for example to the use of hydrogen in a fuel cell for generating electricity, or the use of ammonia in applications for reducing nitrogen oxides NOₓ by Selective Catalytic Reduction (SCR), in particular for the reduction of pollutant emissions by internal combustion engines, in particular diesel engines. The invention thus relates to an ammonia storage structure in particular for the selective catalytic reduction of nitrogen oxides in exhaust gases of combustion vehicles, comprising at least one storage material wherein ammonia can be stored. The invention also relates to systems comprising such a structure.

The reduction of pollutant emissions related to transport has been developed for thirty years. The gradual increase of the severity of emission limits for the four regulated pollutants (CO, HC, NOₓ, particulates) allowed air quality to be significantly improved in particular in large urban areas.

The ever growing use of motor cars requires the pursuit of efforts to still further reduce these pollutant emissions. A decrease in the tolerance towards European emission thresholds is expected in 2014 within the steps of the entry into force of the Euro6 standard. Such measures aim at reducing local pollution. Within this context, it is desirable to reduce nitrogen oxides (NOₓ) in a lean mixture, that is a mixture comprising excess oxygen.

On the other hand, the fuel consumption, in direct connection with CO₂ emissions, has become a major issue in the automotive industry in a few years. Thus, a regulation has been implemented at the European level from 2012 to limit CO₂ emissions of personal vehicles. It is now established that this limit will be decreased on a regular basis for the decades to come. This double issue: reduction of local pollution (NOₓ), and reduction of fuel consumption (CO₂), is particularly restrictive for the diesel engine the lean mixture combustion of which is accompanied with NOₓ emissions difficult to treat.

Within this context, the post-treatment SCR (Selective Catalytic Reduction) technology is used both for personal vehicles and vehicles assigned to the transport of goods. An SCR system generally enables nitrogen oxides NOx to be reduced by selective catalytic reduction. It is also possible to optimally operate an engine in terms of yield at the expense of significant NOx emissions, these NOₓ emissions being then treated in the exhaust by an SCR system allowing a NOx reduction with a strong efficiency. To allow the implementation of such an SCR technology, it is required to have a reducing agent for the reduction of nitrogen oxides on-board the vehicle.

An SCR system currently retained by heavy goods vehicles uses urea in aqueous solution as a reducing agent. When injected in the exhaust, the urea is decomposed by the effect of temperature of the exhaust gases into ammonia (NH₃) and enables NOₓ to be reduced on a specific catalyst. An aqueous urea solution retained and standardized for the operation of SCR systems currently in line is referenced as AUS32 (the commercial brand in Europe being Adblue®).

This method is subjected to some limitations. It has a limited cold efficiency (when the engine is not yet warm). Yet, such a situation exists in several cases, in particular for city buses.

On the other hand, the urea tank has high mass and volume, typically 15 to 30 L for a personal vehicle, 40 to 80 L for a heavy goods vehicle. Such overall dimensions cause an integration complexity in the vehicle which is all the more significant that the vehicle is small. This results in a high depollution cost, as well as an excess mass to the detriment of the vehicle fuel consumption and thus the CO₂ emissions.

Therefore, alternative storage methods have been contemplated to attempt to dispense with these limitations. The option consisting in storing the gas under pressure in an empty tank has also drawbacks, in particular in terms of compactness and safety of operation. This is particularly applicable to ammonia gas storage.

Another method consists in storing gas inside a so-called storage material, in which the gas is absorbed. This storage material, for example a salt, is provided in a storage enclosure. The gas storage (typically ammonia which is the example that will be developed here, even if this principle is applicable to the storage of other gases) is therefore carried out within the salt through the formation of an ammoniate type chemical complex.

In the following paragraph, the chemical processes of ammonia sorption in a material such as a salt are discussed in further detail. In a storage structure, a pulverulent salt is chosen from alkaline earth chlorides as a storage material. In particular, the pulverulent salt can be chosen from the following compounds: SrCl₂, MgCl₂, BaCl₂, CaCl₂, NaCl₂.

The storage of ammonia in such a storage material relies on a solid-gas reversible reaction of the type:

<Solid A>+(Gas)⇄<Solid B>

The ammonia forms coordination complexes also called ammoniates with the alkaline earth chlorides. This phenomenon is known to those skilled in the art.

For example, the reactions of ammonia with strontium chloride are:

SrCl₂ (s)+NH₃ (g)⇄Sr(NH₃)Cl₂ (s)

Sr(NH₃)Cl₂ (s)+7NH₃ (g)⇄Sr(NH₃)₈Cl₂ (s)

Likewise, the single reaction of ammonia with barium chloride is:

BaCl₂ (s)+8 NH₃ (g)⇄Ba(NH₃)₈Cl₂ (s)

The chemical absorption of the ammonia ligand by the SrCl₂ absorbent and BaCl2 causes, between the solid and gas, an electron transfer which results in chemical bonds between NH₃ and the outer shell of the atoms of SrCl₂ and BaCl₂. Penetration of gas into the structure of the solid is made in the entire mass by a diffusion process. This reaction is reversible, since the absorption is exothermic and the desorption endothermic.

This storage type has advantages. The storage within a salt actually allows a significant reduction in the mass and volume of the storage tank. It also allows a benefit in terms of CO₂ balance because of the decrease in the mass of the reducing agent for a given ammonia autonomy. With respect to the urea storage in aqueous solution, the additional amount of water provided to dilute urea in a conventional SCR configuration called a liquid configuration, is saved.

On the other hand, this storage type enables a cold NOₓ absorption with a higher efficiency to be implemented. This storage type moreover allows a reduction in the manufacturing costs because the system for feeding and injecting ammonia can be simplified. The rest of this text will focus on this storage type.

To limit the overall dimensions of the storage enclosure, car manufacturers favour filling or replacing the storage enclosure, for example during engine maintenance, at the time of oil change, or upon filling a fuel tank. According to the actually retained hypothesis, the amount of ammonia on-board a personal vehicle will be in the order of 6 kg for an equivalent 16 litres of an AUS32 type urea solution, which enables the autonomy of the personal vehicle to be provided between two oil change intervals of the vehicle. To enable an SCR system to be fed with ammonia, there is provided a heating element, being electric or via a coolant fluid for example, controlled so as to release, in a dosed manner under each operating condition, ammonia for treating nitrogen oxides.

In a contemplated operating mode, once the storage enclosure (for example a cartridge—these two terms “enclosures” and “cartridge” can be used in this text) is empty, it is replaced by a full cartridge, for example during vehicle maintenance, the empty cartridge being sent back to a filling plant. A cartridge will thus be able to undergo from ten to fifteen emptying/filling cycles. According to the strategies of the manufacturers, the exchange frequency of the storage enclosures and their exchange modalities can be modulated.

The storage of ammonia as an absorbed gas thus has advantages relative to an Adblue aqueous solution (gain in terms of volume, increased cold efficiency, greater compactness of the mixing zone with the exhaust gases, . . . ). The purpose of the invention is to enable known SCR systems to be further improved.

In particular, different aspects of the invention aim at providing a solution to at least one of the following problems:
to dispense to some extent with the contradiction inherent to the known devices, between searching for a minimum pressure of the gas in the storage enclosure, and minimizing power (typically of an electric origin) required for releasing the stored ammonia gas,
the difficulty in gauging the level of a gas, even more so when stored in a solid matrix. In this regard, planning the exchange of empty cartridges with full cartridges will be widely facilitated if it were possible to gauge the level of said cartridges over time,
the heterogeneity gradually set up in the cartridge by the emptying process of said cartridges during the life of the system. This gradual emptying will indeed induce a gradual heterogeneity within the storage matrix, with the result that this can cause a change in the system performance over time. Sooner or later, this could also cause a change in the peculiar characteristics of this matrix, and hence durability problems.

To provide at least one of these solutions, the invention provides an ammonia storage structure in particular for the selective catalytic reduction of nitrogen oxides in the exhaust gases of combustion vehicles, comprising at least one storage material in which ammonia can be stored, characterized in that it comprises at least two distinct storage parts, each storage part containing a storage material, each storage part being associated with a respective heating element, such that both storage parts can be heated differently in order to release differently the ammonia thereof.

Advantageous but in no way limiting aspects of such a structure are the following ones:
control means are associated with each heating element to individually control said heating element, for selectively increasing the temperature of the storage part associated therewith,
the heating element associated with a storage part is a resistor, contacted with, or placed in proximity to the storage part to heat it,
the resistors respectively associated with different storage parts have different resistance values,
the resistors are fed by a single electric power source,
at least the storage materials of the different storage parts have different thermal conductivities,
the structure comprises at least two distinct storage parts, each storage part containing a storage material, not all the storage materials of the different storage parts being identical,
the different storage materials have different sorption enthalpies,
the different storage materials have different porosities, or different pore size distributions,
at least some of the storage materials are in powdered form,
at least some of the storage materials are in the form of rigid elements,
the materials are chosen from alkaline earth chlorides, in particular in the form of SrCl₂, MgCl₂, BaCl₂, CaCl₂ or NaCl₂ salt,
the storage parts are provided adjacent to each other and means are provided for allowing a flow of ammonia gas between two adjacent storage parts,
the structure comprises means allowing a flow of ammonia gas between two adjacent storage parts,
said means allowing a flow of ammonia gas between two adjacent storage parts are controlled to control the flow of ammonia gas between two adjacent storage parts,
the structure comprises, for allowing a flow of ammonia gas between two adjacent storage parts, a passive gas transport device such as a duct or a diffuser.

The invention also relates to an ammonia storage and removal system of a vehicle comprising a storage enclosure, the storage enclosure comprising a storage structure according to one of the aspects above. The invention also relates to a method for controlling a storage structure of an ammonia storage and removal system as previously described, the method comprising:
a first step of controlling the heating element of the first storage part so as to release ammonia stored in the first storage part, and
a second step of following up the amount of ammonia released by the first storage part and/or the amount of ammonia stored in the first storage part.

The variation in the amount of ammonia from the first storage parts can thus be independently followed by the second storage part, in particular whereas ammonia is stored in the second storage part without the second storage part releasing stored ammonia.

Advantageous but in no way limiting aspects of such a method are the following ones:
in response to an indication by the sensor of the first storage part that the amount of stored ammonia is lower than a given threshold, a third step of releasing ammonia stored into the second storage part;
the third step comprises controlling a heating element of the second storage part so as to release ammonia stored in the second storage part;
the third step comprises controlling the opening of controlled sealing means separating the first storage part from the second storage part;
a fourth step of following up the amount of ammonia released by the second storage part and/or the amount of ammonia stored in the second storage part.

The invention also relates to a selective catalytic reduction system for exhaust gases of an internal combustion engine, comprising an ammonia storage system as mentioned above and a module for injecting ammonia in the exhaust gases. According to an advantageous but in no way limiting aspect, the selective catalytic reduction system for exhaust gases of an internal combustion engine comprises control means configured to implement a controlling method as previously described.

### BRIEF DESCRIPTION OF THE FIGURES

Further characteristics, purposes and advantages of the invention will appear upon reading the description hereinafter of the invention. In the appended drawings:

FIG. 1 represents a heat engine equipped with an SCR post-treatment system by ammonia injection according to the invention.

FIG. 2 represents the pencil of pressure/temperature characteristic curves, called Clausius/Clapeyron curves, for different salts that can be used for the absorption storage of ammonia.

FIG. 3 represents different ways to connect two storage parts to each other.

FIG. 4 represents a storage system according to the invention, aiming at providing a compromise between consumed heating electric power and transport safety of unit cartridges from production plants to assembling stations, whether original equipment or after-sales.

FIG. 5 represents a hybrid storage system and the control thereof enabling the discrete gauging of the cartridge to be carried out over time.

FIG. 6 represents an example of a controlling method according to an exemplary embodiment of the invention.

### DETAILED DESCRIPTION

General Architecture of the SCR Post-Treatment System

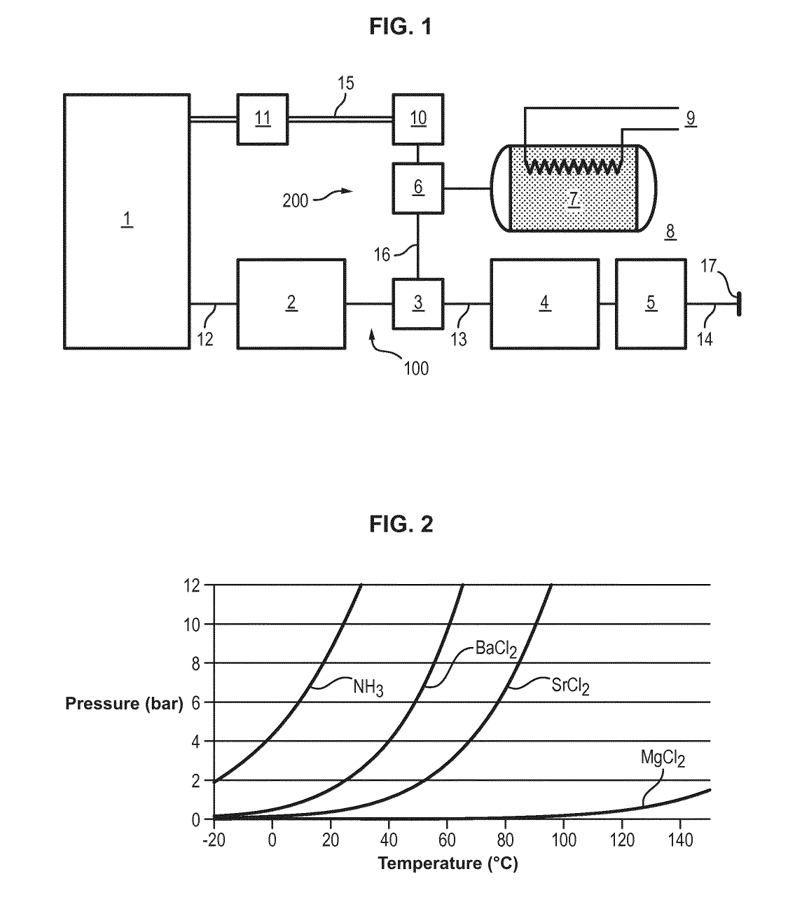

In FIG. 1, a heat engine 1 equipped with an SCR post-treatment system by ammonia injection is schematically represented. The heat engine can be an internal combustion engine, for example a diesel engine, or a lean mixture gasoline engine such as a stratified mixture direct injection engine.

The engine 1 is driven by an electronic calculator 11 which regulates its operation. At the outlet of the engine, exhaust gases 12 are directed to a depollution device 2. The depollution device 2 can comprise an oxidation catalyst or a three-way catalyst. The depollution system can further comprise a particulate filter.

Ammonia gas 16 is injected at an exhaust system 100 of the engine, at the outlet of the engine, this ammonia being mixed with the exhaust gases by means of an injection module 3 provided for example downstream of the depollution device 2 to form an ammonia/exhaust gases mixture 13. The ammonia/exhaust gases mixture 13 then passes through an SCR catalyst 4 which enables NOx to be reduced by ammonia. Further post-treatment elements 5 can be positioned after the SCR catalyst. The further elements 5 can comprise a particulate filter or an oxidation catalyst.

The exhaust gases are thus in the form of depolluted exhaust gases 14 at the outlet of the further elements 5. The depolluted exhaust gases are then directed to an exhaust outlet 17. Thus, the exhaust 100 comprises, from upstream, on the engine 1 side, to downstream, on the outlet 17 side, the depollution element 2, the injection module 3, the SCR catalyst 4 and possibly the further elements 5.

To provide supplying and dosing of ammonia 16 at the inlet of the injection module 3, the system comprises an ammonia storage enclosure 8 containing a storage structure 7 for storing ammonia and releasing it in gaseous form. The structure 7 can be driven in temperature by a warming up device 9. The warming up device 9 comprises for example a resistor or a heat exchanger fed by a coolant fluid such as the coolant of the engine.

The structure 7 can comprise channels for conveying ammonia from outside the enclosure 8 to the ammonia storage parts (which comprise storage materials, which will be described) and/or in the reverse direction. The storage enclosure 8 is preferably connected to a device 6 for controlling the pressure of the enclosure and dosing ammonia to the injection module 3. This device 6 can be driven by a dedicated electronic controller 10 connected to the electronic calculator 11 of the engine.

The system thus comprises an ammonia supply circuit 200 comprising, from upstream to downstream in the flow direction of ammonia, the storage enclosure 8, the device 6 and the injection module 3 in the exhaust 100. In an alternative configuration not represented, the device 6 can be directly driven by the engine calculator 11.

The Structure Comprises at Least Two Different Storage Parts

In the case of the invention, the ammonia storage structure 7 not only comprises a storage material in which ammonia can be stored, but at least two distinct storage parts, each storage part containing a storage material. The ammonia storage structure comprises for example at least three storage parts.

As will be seen, all the storage parts are not able to release ammonia gas they contain under the same conditions. In other words, some storage parts are configured to be capable of releasing their ammonia gas more readily than other storage parts, even if they initially contained the same amount of ammonia as the other parts. For the sake of clarity of the disclosure, the simple case in which the structure comprises two storage parts will be illustrated about two main embodiments. It is however possible that the structure comprises any number of storage parts, higher than or equal to two.

The at least two storage parts, or plurality of storage parts, is typically included in a storage structure provided in a storage enclosure, such that the plurality of storage parts is provided in the enclosure. The first storage part can be associated with a sensor for following up the amount of ammonia stored in the first storage part. Such a sensor is for example a dedicated pressure sensor.

The second storage part can be associated with a sensor for following up the amount of ammonia stored in the second storage part. Such a sensor can for example be a dedicated pressure sensor.

Two main embodiments according to which the storage parts can release the ammonia thereof differently will now be disclosed. These two embodiments can be implemented independently of each other. They can also be combined.

According to a first embodiment which will be detailed, this differentiated ammonia releasibility is achieved by providing that the storage materials included in both storage parts are different. According to a second embodiment that will be detailed, this differentiated ammonia releasibility is achieved by providing that the storage materials included in both storage parts are heated differently.

Prior to the description of both these main embodiments, some physical principles will be usefully reminded. FIG. 2 represents pressure/temperature characteristic curves, called Clausius/Clapeyron curves for different salts that can be used for the absorption storage of ammonia. These curves illustrate, for a given amount of ammonia, that for a given temperature, the safe working pressure of stability of ammonia NH3 when this ammonia is fixed on different supports.

In the free state, ammonia will be at a certain pressure given by the NH3 curve. When ammonia is fixed in a solid matrix comprised of certain salts, ammonia remains stably absorbed in the salt and, as a function of temperature, part of ammonia can be outside the solid matrix of the salt, in gaseous form, with a certain pressure. As a function of the salt used as an ammonia storage material for the solid matrix, the ability to retain a more or less great amount of ammonia in absorbed form will be different.

Thus, the MgCl2 salt has a higher ability than the SrCl2 salt, and even higher than the BaCl2 salt. At 40° C. for example, the MgCl2 salt retains ammonia absorbed in its solid matrix, whereas for a same amount of ammonia, the SrCl2 salt can only fix part of ammonia in absorbed form in the solid matrix of the salt, the rest of ammonia being in gaseous form, setting a pressure (of a value in the order of 1 bar). The BaCl2 salt has itself an absorption ability even lower such that for the same total amount of ammonia and still at 40° C., the ammonia gas is in a higher amount and keeps a pressure of almost 6 bars. The MgCl2 storage material is thus more stable than the SrCl2 material, itself more stable than the BaCl2 material.

The invention advantageously exploits these characteristics, according to two embodiments that will be described based on a simple configuration with only two storage parts. The invention can also exploit differences between storage materials which do not relate to the chemical compositions of the materials, but their porosity, or more generally their ability to transport trapped gas into the material—this ability being in particular determined by the pore size distribution in the material.

First Main Embodiment: Use of Different Storage Materials

According to a first main embodiment, both storage parts can release differently the ammonia thereof because they respectively contain two different storage materials. The notion of different materials will be defined more precisely in this section. The storage materials are typically salts, which can be in powdered form, or even in precompressed form, forming one or more rigid elements. The storage materials are preferably chosen from the alkaline earth chlorides, in particular in the form of SrCl₂, MgCl₂, BaCl₂, CaCl₂, or NaCl₂ salt.

To have storage materials that can release differently the ammonia thereof, use can be made in particular of:
chemically different materials (by selecting two different compositions, for example in the list above). In this case, the different storage materials have different thermodynamic properties (typically sorption enthalpies),
the same material, but with two different porosities, or more generally two abilities to transport trapped gas into the material—this ability being in particular determined by the pore size distribution in the material.
In this regard, a powdered salt will have a different rheology, and hence will have a different behaviour, relative to a material having the same chemical composition that will have been compressed beforehand, for example to make it as a rigid element of compressed salt (that can have a form of a slab).
Other modes for differentiating properties of a material can be contemplated, for example, by conducting a sintering under different temperature conditions of two samples of a same salt.

Thus, it is possible to fill (or “load”) each of the different storage parts with the same amount of ammonia, and each of these parts will release the ammonia thereof differently, as a function of the storage material included in the storage part, even when the different parts are at the same temperature. As will be seen later in this text, the storage parts can on the other hand exchange ammonia gas between them, this ammonia being able to flow from one storage part to the other (freely, or in a controlled manner). This first main embodiment enables, by choosing different storage materials, ammonia stored in the different parts to be selectively released differently.

Second Main Embodiment: Differentiated Heating of the Storage Parts

According to a second main embodiment, both storage parts can release differently the ammonia thereof because they are heated differently. In this case, each storage part is associated with a respective heating element. Each storage part can contain the heating element associated therewith. The heating element is typically a resistor, contacted with, or placed in proximity to the storage part to heat it.

Each heating element is individually controlled, to selectively increase the temperature of the storage part associated therewith. Hence, the temperature of the storage material contained in the storage part will be in turn selectively increased. It is for example possible to provide that the resistors respectively associated with different storage parts, have different resistance values.

In this case, a heating power differential can be established between different storage parts particularly simply, by feeding the resistors with a single electric power source. In this simple case, all the heating elements, or several of them, are collectively controlled. It is also possible to use, to establish a temperature differential between storage parts, the differences in thermal conductivity between the storage materials of these different parts. This second embodiment thus makes up a second means for both storage parts to release the ammonia thereof differently.

Communication Between the Storage Parts

Whether with the first main embodiment, the second main embodiment, or with a mixed embodiment (in which storage parts comprise different storage materials, and further storage parts are selectively heated), the storage parts (which can be in any number) are provided adjacent to each other, preferably in series. These storage parts can be separated from each other by walls (gas permeable or not) which thus partition the inner space of the structure 7. The storage parts can also be adjoining each other without intermediate walls.

Means are provided for allowing a flow of ammonia gas between two adjacent storage parts. This ammonia gas which comes from a storage part, has been released by said storage parts whereas other storage parts could release a different amount of ammonia gas, or do not release it at all (as a function of the storage material and/or the heating applied to the storage part). The means allowing a flow of ammonia gas between two adjacent storage parts can be controlled to control the flow of ammonia gas between two adjacent storage parts.

In this case, these means allowing a flow of ammonia gas between two adjacent storage parts can be controlled sealing means. In particular, the controlled sealing means can for example allow a flow of ammonia gas between both adjacent storage parts or prevent such a flow as a function of an opening or closing order of the controlled sealing means.

In a simplified configuration, the means allowing flow of ammonia gas between two adjacent storage parts can also be “passive” means, for example in the form of a gas transport device such as a duct or a diffuser. It is also possible that the structure comprises, for allowing a flow of ammonia gas between two adjacent storage parts an intermediate element provided with walls or the porosity of which enables ammonia gas to be diffused. It is even possible to directly contact both storage materials, of two adjacent storage parts, so as to create in the structure 7 regions in which the ammonia gas will be more or less concentrated, wherein this ammonia can flow directly between both contacting regions.

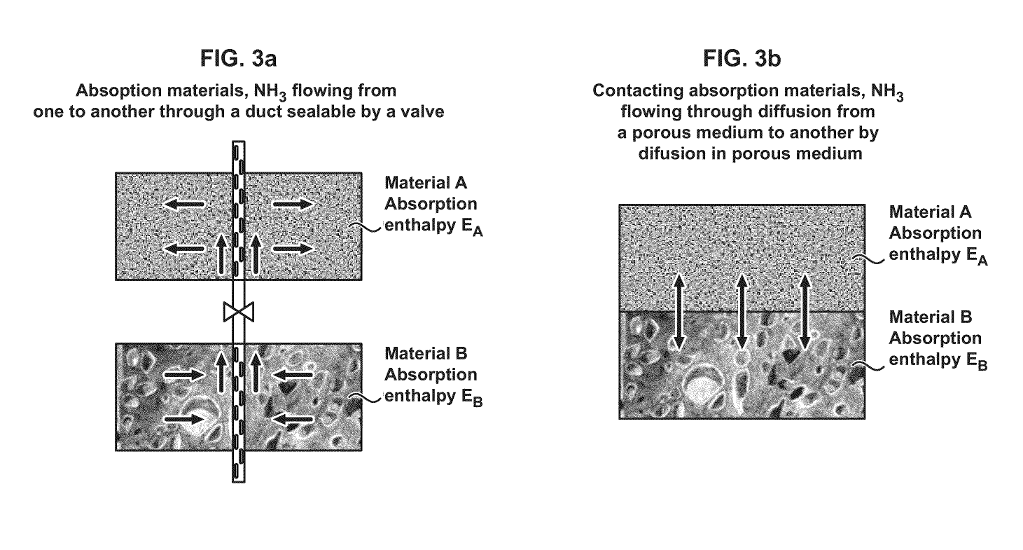

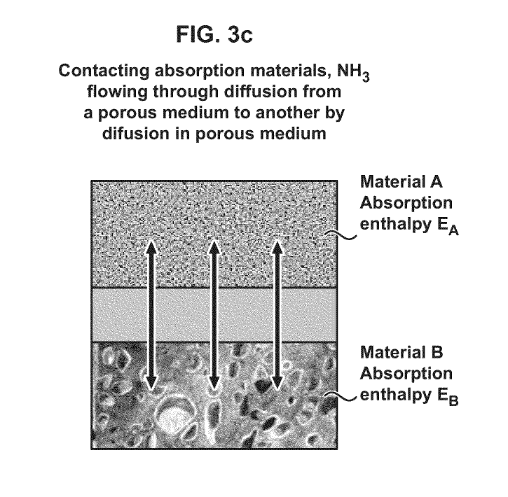

By way of example, FIG. 3 represents different ways of connecting two storage parts to each other. It is set forth that on this FIG. 3, the different properties of the materials are achieved by different chemical compositions (different sorption enthalpies). But the architectures and principles illustrated in this FIG. 3 are also applicable when the different properties of the materials are obtained by different heat arrangements (different heating and/or different porosities).

In FIG. 3a, a material having a storage characteristic a, defining a first storage part, is separated from a material having a characteristic b, defining a second storage part, by a duct allowing the flow of ammonia, sealable by a valve drivable from the calculator 11 of FIG. 1. The ammonia flow from one storage part to the other can be made in either direction. Each of the storage materials is in this example located into two separate containers, wherein both materials can be alternately implanted in two compartments separated by a partition wall.

In FIG. 3b, both storage materials of both storage parts are in direct contact, the flow from one to the other being made via the porosities of both materials. In FIG. 3c, both materials of both storage parts are separated by a permeable membrane allowing the ammonia flow in either direction.

A permeable membrane separating two storage parts is for example a separating layer of a material the permeability of which to the ammonia flow can vary as a function of the state of the separating layer. In particular, as a function of the state of the separating layer, the latter can have a permeability that can take different values, for example, as a function of this state of the separating layer, for substantially allowing the ammonia flow or substantially prevent it. It is thus possible to modify the ammonia flow within the storage structure, or to enable ammonia stored to be kept in a given storage part, and thus an ammonia reserve to be made or the amount of ammonia gas produced by heating to be better controlled.

The separating layer is for example associated with a heating element. Such a heating element is for example the heating element of a storage part that the separating layer separates. Alternatively, such a heating element is for example a dedicated heating element distinct from a possible heating element of a storage part of the storage structure or several possible heating elements of storage parts of the storage structure.

Such a separating layer can for example allow itself an ammonia storage. It is thus possible to achieve the advantages of a separating layer between two storage parts while using the space occupied by the separating layer for ammonia storage. The separating layer has for example a volume storage capacity for ammonia being lower than that of the storage parts.

Such a separating layer comprises for example a material having a chemical composition common with at least one of the storage layers that the separating layer separates, for example with two of the storage layers separated, the material having a different particle size distribution or a different compression rate, typically a higher compression rate. It is thus possible to readily make a separating layer, for example by strongly compressing a storage layer upon forming the storage structure.

The separating layer comprises for example graphite or can be made of graphite. Graphite has the advantage of having an ammonia permeability varying with temperature while enabling ammonia to be stored. Moreover, a separating layer of graphite, associated with a heating element, enables the ammonia flow rate from the second storage part to be accurately controlled.

Additional Information About the System

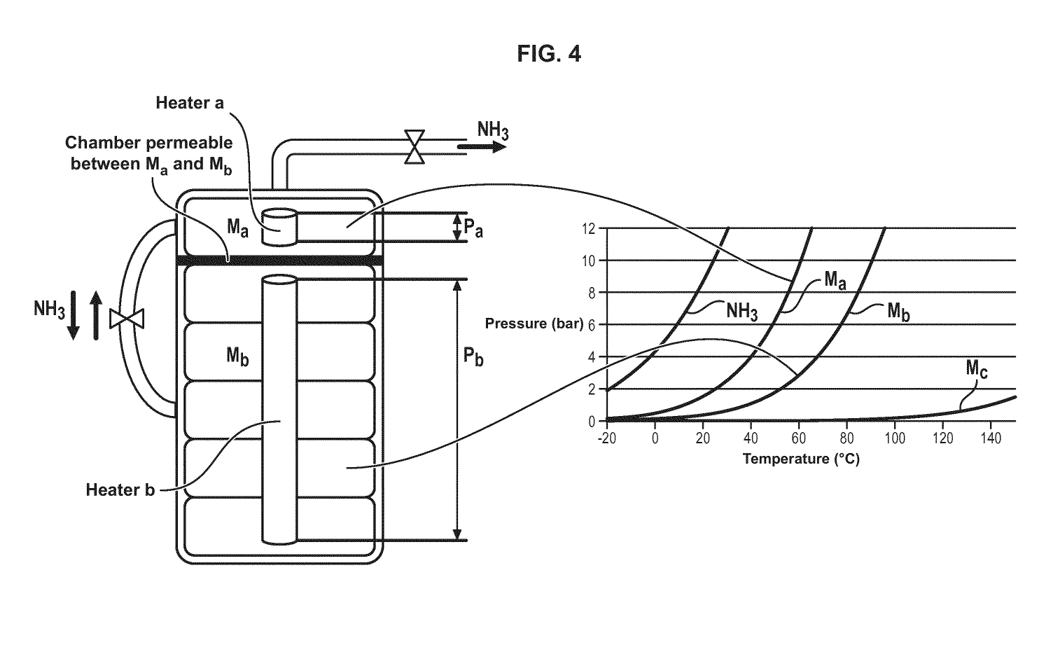

The invention also provides an ammonia storage and removal system of a vehicle comprising a storage enclosure, with a storage enclosure comprising a storage structure according to one or more of the aspects described above. It also provides a selective catalytic reduction system for exhaust gases of an internal combustion engine, comprising such an ammonia storage system and a module for injecting ammonia in the exhaust gases. FIG. 4 thus represents a hybrid storage system allowing a compromise to be provided between consumed heating electric power and transport safety of unit cartridges from production plants to assembling stations, whether original equipment or after sales.

Indeed, advantageously in the case of the invention, the storage matrix of the storage structure is predominantly made with one or more storage material(s) enabling for example the pressure to be kept lower than or equal to 1 bar absolute, that is that can also be considered as a “solid” by virtue of the regulations regarding the transport of hazardous materials. Only a certain region Mb of the storage structure (corresponding to one or more “storage part(s)”) is occupied by a storage material having a lower stability, that is allowing at an equivalent temperature, a higher saturation pressure, and thus having a higher reactivity towards ammonia injection in the exhaust line. The ammonia distribution management between the different parts of the cartridge consists for example in leaving the least stable storage matrix Mb empty or hardly filled, during the transport phases of the structure (which will make up for example a cartridge).

Once the cartridge is mounted in the system and connected to a control member such as the element 11 of FIG. 1, a valve connecting both regions Ma, Mb of the cartridge is activated to open it, the most stable storage material can further be selectively heated (by the device 9 of FIG. 1) to establish a temperature, and hence a pressure, differential, with the least stable material. Hence, the pressure deviation between both regions of the cartridge causes a flow of ammonia gas between them, and ammonia occupies the least stable (the most reactive) region.

The gaseous saturation of this region with ammoniac is then facilitated, such that this region is ready to be injected to the exhaust under very favourable reactivity and electric energy saving conditions (little energy has been expended for the heating initiating this reaction). It will be advantageously provided that the least stable region is arranged in the cartridge in close proximity to the outlet of the cartridge which supplies the element 6 of FIG. 1, to supply the exhaust line 100 with ammonia gas. Thus, during the transport of packaged cartridges to the system in which they have to be mounted, the most stable storage parts of the cartridge contain ammonia with a concentration higher than the other storage parts, which are closer to the outlet of the cartridge.

When the cartridge is in place in the system, the most stable storage parts can be activated (by selective heating) which increases the pressure of ammonia gas in these parts, and this ammonia is released to the least stable parts of the cartridge. These least stable parts (least stable because they contain a less stable storage material than the more stable parts) are those from which it is easier to remove ammonia, and they are the parts that have been preferably provided immediately close to the supply outlet of the cartridge to the engine exhaust.

Preferably, the control member such as a valve between the stable and less stable parts is controlled to avoid a reversible recirculation of ammoniac to the most stable material. In this regard, an adapted valve opening sequence will be provided, by:
activating the most stable parts such that they release ammonia gas,
opening the fluid communication between these stable parts and the least stable parts, so as to “load” the least stable parts with ammonia until they are brought to a pressure reaching a pressure value able to supply the exhaust line of the engine, or close to this pressure value,
closing this communication to avoid ammonia from coming back to the most stable parts,
activating through heating the least stable parts to further increase the ammonia pressure therein, in order to supply the exhaust line.

Application to Gauging

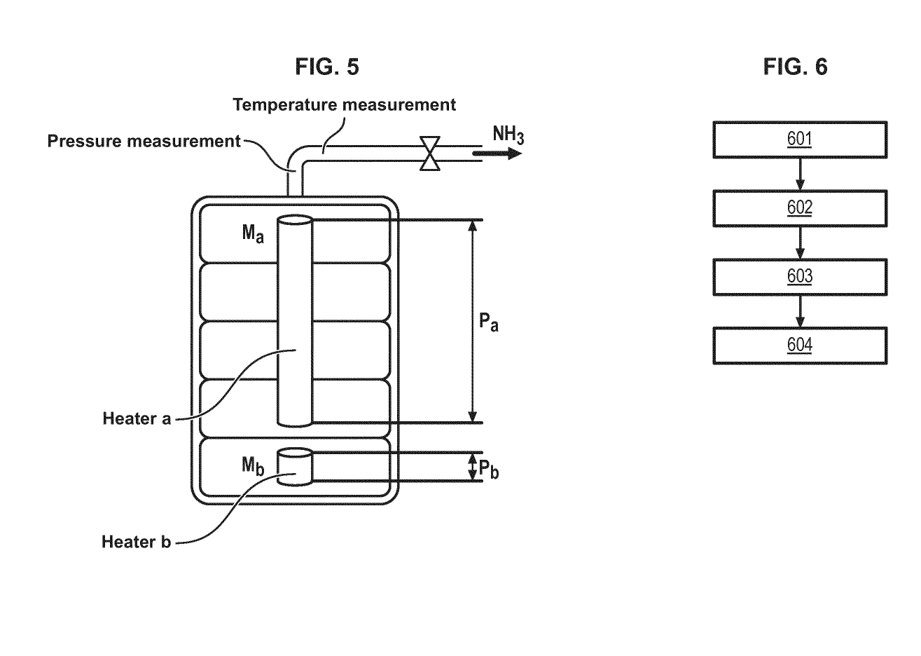

FIG. 5 represents a hybrid storage system and the control thereof, enabling the cartridge gauging to be performed over time. For example, a part Ma of the cartridge consists of a hardly stable salt, suitable for injecting ammonia to the exhaust at the expense of an activation with a reduced electric energy. A part Mb of the cartridge is, as in the case of FIG. 4, filled with a more stable material.

Both parts Ma and Mb can be separated by an ammonia gas proof wall. The part Mb, being more stable, is initially saturated with ammonia. Therefore, it can no longer accommodate ammonia. Each part Ma, Mb is associated with a respective heating circuit, that can release a respective heating power Pa, Pb.

A pressure sensor is further provided so as to measure the pressure prevailing at the part Ma. This part preferably corresponds to a single volume. In operation, the heating circuit of the part Ma is activated to activate the material of this part in order to diffuse ammonia gas, towards the exhaust line. The pressure in the part Ma is measured continuously, or at regular intervals.

As a result of the ammonia discharge outside the cartridge from the part Ma, the pressure in this part will tend to decrease. The decrease in pressure will become significant when ammonia trapped in the material of the part Ma will be depleted, even if the heating of the part Ma would remain activated. Before this depletion, the decrease in the pressure will be limited as long as the material of the part Ma remains activated, and releases its ammonia.

It is thus possible to detect, by following up the pressure in the part Ma, the ammonia depletion in this part. It is set forth that during the ammonia release phase by the part Ma, the part Mb is not activated (that is it is not heated to the point that it releases the ammonia thereof). Ammonia stored therein thus remains in reserve.

When the ammonia depletion of the part Ma is detected, this part Mb is activated through heating the part Mb. Therefore, it releases the ammonia thereof, towards the part Ma. In practice, the detection of this “switching to the reserve” consisting of the part Mb is used as an alert mark indicating the necessity to replace or refill the cartridge.

Example of Control Method

In reference to FIG. 6, a method for controlling a storage structure as previously described is described, for example of a storage structure of a storage system as previously described. The storage structure thus comprises at least one first storage part and a second storage part. The first storage part is connected to means for flowing ammonia gas to the storage structure and/or outside the storage structure.

The first storage structure can be associated with a respective heating element in order to release the ammonia thereof. The method can thus comprise a first step 601 of controlling the heating element of the first storage part so as to release ammonia stored in the first storage part, the ammonia release being typically selective such that ammonia stored in the second storage part is not released. The method can thus comprise a second step 602 of following up the amount of ammonia released by the first storage part and/or the amount of ammonia stored in the first storage part. This step can be performed during the ammonia release or consecutively to the ammonia release.

To allow such a follow up, the first storage part can be associated with a sensor for following up the amount of ammonia stored in the first storage part. Such a sensor is for example a dedicated pressure sensor. The variation in the amount of ammonia from the first storage part can thus be followed up independently of the variation in the amount of ammonia from the second storage part, in particular whereas ammonia is stored in the second storage part without the second storage part releasing stored ammonia. It is thus possible to fully deplete the first storage part while keeping in reserve ammonia stored in the second storage part.

The method can especially comprise, in response to an indication by the sensor of the first storage part that the amount of ammonia stored is lower than a given threshold, typically that the amount of ammonia stored by the first storage part is zero, a third step 603 of releasing ammonia stored in the second storage part. Such a third step 603 can for example comprise controlling a heating element of the second storage part so as to release ammonia stored in the second storage part, the ammonia release being typically selective such that ammonia stored in the second storage part is released independently of the first storage part. Alternatively or additionally, such a third step 603 can comprise controlling the opening of controlled sealing means separating the first storage part from the second storage part. As previously indicated, the sealing means are typically formed by a controlled separating layer, typically a layer comprising graphite. Such an opening control can for example be performed together with the release of ammonia stored in the second storage part, for example when the sealing means comprise a separating layer with which the same heating element as that of the second storage part or a distinct heating element is associated.

The method can comprise a fourth step 604, for example a successive one, of following up the amount of ammonia released by the second storage part and/or the amount of ammonia stored in the second storage part. The variation in the amount of ammonia from the second storage part can thus be followed up independently of the first storage part. It is thus possible to achieve a more accurate gauging of the amount of ammonia in the storage structure.

Indeed, according to prior art, gauging is typically performed by a flow rate meter at the outlet of the storage enclosure. The measurement of an amount according to prior art is delicate and liable to be inaccurate because it requires to accurately follow up the outflow rate permanently. Furthermore, such a measurement according to prior art does not enable the amount of ammonia stored to be followed up in case of leak.

On the contrary, such a method implemented at such a structure enables the ammonia amount to be finely followed up in each storage part and a control enabling the ammonia release to be more accurately managed. It is in particular possible to prevent the structure from being too quickly emptied or to limit the amounts of ammonia needlessly released in case of a significant need for ammonia followed by an abrupt interruption in this need. In prior art, heating the entire storage structure implies that if the ammonia demand is abruptly stopped, since the structure is already heated, it will continue to be emptied because it is delicate to block the discharge of the ammonia released in gaseous form for safety reasons.

The system according to the invention makes it possible for example to wait that the amount of ammonia of a given storage part is sufficiently emptied before controlling the ammonia release of the next storage part. Thus, if the need ceases as a result of a first control implying a strong ammonia release, only the first storage part is likely to be emptied, the other part keeping the ammonia thereof, preferably thanks to the sealing means, and even more particularly thanks to the separating layer.

Further, such a method associated with such a system enables the ammonia release to be better dimensioned with respect to the needs. Since the storage parts are separate, it is possible to release ammonia stored only in one of them. The more distinct storage parts the structure contains, the more accurate the driving.

In particular, it is possible to know the amount of ammonia stored in the different storage parts and thus in particular to know the accurate location of a possible leak in the enclosure. In particular, when the storage parts are separated by controlled sealing means, it is thus possible to avoid that all of ammonia is released in case of leak. In particular, the storage structure can be associated with control means configured to implement such a control method.

The selective catalytic reduction system for exhaust gases of an internal combustion engine comprises for example such control means. The control means comprise for example a dedicated electronic controller 10 connected to the electronic calculator 11 of the engine or are included in the electronic calculator 11.

1-16. (canceled)

17. An ammonia storage structure, in particular for selective catalytic reduction of nitrogen oxides in exhaust gases of combustion vehicles, comprising at least one storage material in which ammonia can be stored, wherein it comprises at least two distinct storage parts, each storage part containing a storage material, each storage part being associated with a respective heating element, such that both storage parts can be heated differently in order to release differently the ammonia thereof.

18. The storage structure of claim 17 wherein control means are associated with each heating element to individually control the heating element, to selectively increase the temperature of the storage part associated therewith.

19. The storage structure of claim 17 wherein the heating element associated with a storage part is a resistor, contacted with, or placed in proximity to the storage part to heat it.

20. The storage structure of claim 17 wherein the resistors respectively associated with different storage parts have different resistance values.

21. The storage structure of claim 19 wherein the resistors are fed by a single electric power source.

22. The storage structure of claim 17 wherein at least the storage materials of the different storage parts have different thermal conductivities.

23. The storage structure of claim 17 wherein it comprises at least two distinct storage parts, each storage part containing a storage material, not all the storage materials of the different storage parts being identical.

24. The storage structure of claim 23 wherein the different storage materials have different sorption enthalpies, and/or in that the different storage materials have different porosities, or different pore size distributions.

25. The storage structure of claim 17 wherein at least some of the storage materials are in powdered form and/or in that at least some of the storage materials are in the form of rigid elements.

26. The storage structure of claim 17 wherein the storage parts are provided adjacent to each other and means are provided for allowing a flow of ammonia gas between two adjacent storage parts.

27. The storage structure of claim 26 wherein the structure comprises means allowing a flow of ammonia gas between two adjacent storage parts.

28. The storage structure of claim 27 wherein the means allowing a flow of ammonia gas between two adjacent storage parts are controlled to control the flow of ammonia gas between two adjacent storage parts.

29. The storage structure of claim 26, wherein the structure comprises, for allowing a flow of ammonia gas between two adjacent storage parts, a passive gas transport device such as a duct or a diffuser.

30. An ammonia storage and removal system of a vehicle comprising a storage enclosure, wherein the storage enclosure comprises the storage structure of claim 17.

31. A method for controlling a storage structure of an ammonia storage and removal system of a vehicle, the storage structure comprising at least one storage material in which ammonia can be stored, wherein it comprises at least two distinct storage parts, each storage part containing a storage material, each storage part being associated with a respective heating element, such that both storage parts can be heated differently in order to release differently the ammonia thereof, the method comprising:
controlling a heating element of the first storage part so as to release the ammonia stored in the first storage part; and
following up the amount of the ammonia released by the first storage part and/or the amount of the ammonia stored in the first storage part.

32. A selective catalytic reduction system for exhaust gases of an internal combustion engine, wherein it comprises an ammonia storage system of a vehicle, the storage structure comprising at least one storage material in which ammonia can be stored, wherein it comprises at least two distinct storage parts, each storage part containing a storage material, each storage part being associated with a respective heating element, such that both storage parts can be heated differently in order to release differently the ammonia thereof, and a module adapted to inject the ammonia in the exhaust gases.
